(19) United States
(12) Patent Application Publication
(10) Pub. No.: US 2004/0020104 A1
(43) Pub. Date: Feb. 5, 2004

(54) Device for catching flying insects

(76) Inventors: Michael Feldhege, Koblenz (DE); Michael Roreger, Neuwied (DE); Malgorzata Klockzo, Neustad/Wied (DE)

Correspondence Address: William F Lawrence, Frommer Lawrence & Haug, 745 Fifth Avenue, New York, NY, 10151, US

(21) Appl. No.: 10/415,789

(22) PCT Filed: Oct. 4, 2001
(86) PCT No.: PCT/EP01/11455

(30) Foreign Application Priority Data
Nov. 7, 2000 (DE) 100 55 135.1

(51) Int. Cl. A01M 1/14

(52) U.S. Cl. 43/114

(57) ABSTRACT

The invention relates to a device for catching flying insects, which comprises a planar support (1) with a first surface (top surface (2)) and a second surface (lower surface (3)). A layer (5) that contains a substance that attracts insects and/or to which insects stick is provided on at least one of said surfaces. The device further comprises a fastening device (4) by way of which it can be positioned on the application site (for example a window) during utilization in such a way that the surface coated with the substance that attracts insects and/or to which insects stick is in a substantially horizontal position.

The present invention is directed at a device which is suitable for catching flies and other flying insects (gnats, wasps, moths, beetles etc.).

Devices for catching flying insects have long been known, for example insect glue rings and window fly traps as provided by EP 281 562. There are, however, also electrically operated devices of various designs, which attract and kill insects by using UV fluorescent tubes in combination with high-voltage gratings, suction propellers or adhesive sheets, adhesive traps with separate attractant capsules and adhesive traps which emit optical lures of different wavelengths, described in the documents U.S. Pat. Nos. 4,411,093, 4,577,434, 4,908,980, 5,884,801, 5,778,636, 5,713,184, 5,713,183, 5,517,802, JP 8051909, FR 2 468 305 and EP 367 539.

The object of the present invention is to provide a flying insect trap which is of a simple construction, costs little to produce, at the same time is easy for the user to operate and requires a minimum of technical expenditure (as far as possible is of one part, does not use electrical components). At the same time, it is intended to be efficient in attracting and catching flying insects.

The device according to the invention has a planar support (1), which has a first surface (upper side, 2) and a second surface (lower side, 3). On at least one of these surfaces, a layer (5) of a substance which attracts insects and/or to which insects stick is applied. Preferably, it is the upper side (2) that is coated with the substance which attracts insects and/or to which insects stick. Furthermore, this support has a fastening device (4), by way of which it can be attached to the application site during use. This application site may be a wall, a mirror, the inside of a wardrobe, a kitchen cupboard or store cupboard or preferably the glass pane of a window in the interior of a room in a home or office or a vehicle (passenger car, bus, railroad car). During use of the device according to the invention, for example on a window pane, the flying insects are presented with a substantially horizontal surface coated with a substance which attracts insects and/or to which insects stick.

“Substantially horizontal” is to be understood as meaning that the surface coated with the layer (5) is arranged preferably parallel with respect to the horizontal during use of the device. However, it is also intended to cover arrangements in which this surface may be relatively inclined with respect to the horizontal. The limits for “permissible” inclination could be an angle of less than 30° (measured between the plane of the site of use and the side (2) of the device coated with the substance which attracts insects and/or to which insects stick). This limit value is determined by the fact that the risk of side (2) sticking to the application site (for example a window pane) increases as the angle decreases.

Therefore, angles of above 30° are preferred, angles of between 45° and 145° are particularly preferred, angles of between 60° and 120° are most particularly preferred. Since the application site will in most cases be a vertically arranged plane, a “substantially horizontal” arrangement of the coated plane (2) is obtained as a result of the aforementioned angles—that is not only in the ideal case when there is a 90° angle between the application site and the coated plane (2).

The material of which the planar support (1) consists may be opaque. These materials include, for example, board, cardboard etc. or pigment-containing plastics such as polypropylene, polystyrene, polyester etc. and also composite materials of these materials, for example a laminate of cardboard and polyester. However, the material is preferably translucent. This also covers the case in which light is not completely absorbed or transmitted, but instead, if appropriate, only certain wavelength ranges are absorbed, so that the support appears colored and, under some circumstances, even then also largely transparent. The use of a colored planar support may be advantageous if certain flying insects react to such optical signals, as is the case for example with house flies, food moths, wasps, and certain types of beetle, such as the bread beetle.

However, colorless and transparent materials are particularly preferred. These include glass and plastics such as polypropylene, polystyrene, polyester, polyacrylonitrile, ethylene-vinyl acetate polymers, polyester butylene, polyvinyl chloride, polyethylene terephthalate, polyacrylate etc.

Polyester-containing materials in sheet form come into consideration in particular as plastics, since even in low material thicknesses they still have adequate product rigidity and dimensional stability along with advantageous plasticity.

In certain embodiments, geometrical patterns (regularly or irregularly applied stripes, checks, lines and the like) may be located on the side of the planar support which is provided with the substance which attracts insects and/or to which insects stick. Such patterns, which have an attracting effect on certain flying insects, are known to a person skilled in the art and described for example in EP 475 665, EP 446 464, WO 97/01272 and WO 98/42186. These patterns may be, for example, black-and-white rectangles, imitations of blossoms or illustrations of the target insects.

A substance which attracts insects is understood for the purposes of the present description as meaning insect attractants or sexual or aggregation pheromones and their combinations. They are known to a person skilled in the art, such as for example the sexual pheromone of the house fly (Z)-9-tricosene or that of the food moth Z,E-9,12-tetradecadienyl acetate (TDA), which are obtainable for example from Bedoukian Research of Danbury, USA or Shin-Etsu of Tokyo, Japan. However, molasses, syrup, honey and malt, substance mixtures containing sugar and also odor-active substances and feedants can be considered as a substance which attracts insects for the purposes of this invention.

A substance to which insects stick is to be understood for the purposes of the present description as meaning adhesive substances which have the effect of making the insects stick on the side of the device coated with it in such a way that the flying insects are prevented from flying away. These substances are known to a person skilled in the art. They include, for example, from the substance group of adhesive polymers, polyisobutylenes and polyacrylates, such as for example copolymers of acrylic acid and acrylates, in particular alkyl acrylate such as 2-ethylhexyl acrylate or n-butyl acrylate. In the case of non-adhesive copolymers, such as for example polystyrene-isoprene-styrene, polystyrene-butadiene-styrene, polyethylene-vinyl acetate and polyethylene acrylate, suitable auxiliaries, known as tackifiers, must be added to achieve the desired properties. Serving in particular for this purpose are resinous substances such as colophony and its derivatives, polyterpene and hydrocarbon resins.

The substance which attracts insects and/or to which insects stick is applied to at least one surface of the planar support, to be precise in the form of a layer. This may be performed by this substance/these substances being applied to the side concerned of the planar support directly (for example by extrusion) or, if appropriate, dissolved or suspended in a suitable auxiliary substance. If appropriate, the auxiliary substance (for example a solvent) is subsequently removed (for example by evaporation of the solvent).

The substance which attracts insects and/or to which insects stick may, however, also be applied to the at least one surface of the planar support in the form of a previously prepared single-layer, two-layer or multi-layer laminate.

The fastening device (4) may be a material strip which consists of the same material as the support (1) and which is provided with a strip of adhesive (7). The fastening device (4) may be attached separately to the support (1), but can advantageously be produced by folding over along one longitudinal side of the support (1). This produces two parallel-running longitudinal sides (6) on the support (1), which lie opposite each other and one of which then represents the delimiting line between the support (1) and the fastening device (4).

The production of a device according to the invention for catching flying insects which comprises a planar support with an upper side, a lower side and a fastening device can advantageously take place by the steps of a) coating at least one surface of the planar material sheet with a substance which attracts insects and/or to which insects stick, at least one edge region of this surface of the planar material sheet remaining uncoated, b) covering the coated surface with a protective film which can be pulled off again, c) folding over the uncoated edge region of the planar material sheet by an amount of between about 30 and about 150 degrees, preferably about 90 degrees (respectively either upward or downward with respect to the plane of the coated surface), producing a material strip which preferably protrudes permanently from the plane of the coated surface, d) applying adhesive or a double-sided adhesive tape to one of the sides of this material strip and e) covering the adhesive or the double-sided adhesive tape with a protective film which can be pulled off again. Individual devices are obtained by cutting up portions (for example by cross-cutting) of the planar material sheet respectively provided with protective films which can be pulled off again, provided with a coated surface at least on one side and with a material strip provided with adhesive or a double-sided adhesive tape, and packing a number of these portions, preferably four of them, in a sealed-edge or lay-flat film bag.

By performing the folding over according to step c) at an angle other than 90 degrees, it is possible, if appropriate, to take into account that the application site itself is a window pane which is not vertical but is oriented at a certain angle with respect to the ground. Examples of intended application sites which come into consideration here are inclined windows in the roof area of homes or display cabinets in sales areas. Correspondingly adapted folding over, for example more extreme folding over, makes it possible to compensate for the inclination of the intended application site in such a way that, during the use of the device, the surface coated with the substance which attracts insects or to which insects stick is arranged substantially horizontal to the ground.

On account of the material properties of the support (product rigidity, dimensional stability, plasticity), once the folding over has been carried out according to step c) it can be reversed again to make the devices substantially planar. This has advantages when packing the devices. The final angle between the support (1) and the fastening device (4) is only set just before the device is used, by renewed manual folding over by the user. This is then much more easily possible on account of the folding over that has already taken place once (by machine).

When the material strip is coated, the adhesive substance (the adhesive) or the double-sided adhesive tape is preferably applied to the side of the material strip which respectively faces away from the plane of the coated surface. Preferably, the first (i.e. the upper) side of the planar support, surface (2), is coated with the substance which attracts insects and/or to which insects stick and is covered with protective film, and then the uncoated edge region is folded over downward, for example by 90 degrees. The side of the material strip facing away from the coated surface is then the side that was previously part of the upper side (2).

The said method steps may also be performed in a different sequence, for example in the sequence a), b), d), e), c) or a), d), b), e), c).

Instead of the folding edge produced during the folding over according to step c), a line of weakness (notching) or a perforation (small clearances in the material) may also be provided along the delimiting line between the carrier (1) and the fastening device (4). In this case, no folding over by machine is required, but “merely” the manual folding over to be carried out later by the user. In any event, this delimiting line gives a clear differentiation between the support (1) and the fastening device (4), in particular whenever these two elements of the device comprise the same body.

If the support (1) and the fastening device (4) are formed from the same body, the production of such a delimiting line between these structural elements is required—preferably in the uncoated edge region of the side (2).

First comparative tests between the device according to the invention for catching flying insects and a window fly trap from the prior art, as described in EP 281 562, showed that, under otherwise comparable conditions (attachment of the two traps close to each other on the same window pane in the same room, catching area of the same order of magnitude, the same period of use), it was possible to catch a greater number of flying insects with the device according to the invention.

This is presumably partly attributable to the fact that the substantially horizontal surface coated with substance which attracts insects and/or to which insects stick, which is presented to the flying insects by the device according to the invention during its use, is popular with the flying insects as a “landing strip”. This shows that the object is achieved in a surprisingly simple way and at the same time with an unexpectedly effective insect-catching effect.

### EXAMPLE 1

### Comparative Tests on the Efficiency of Adhesive Window Fly Traps

To determine the efficiency of the device according to the invention in comparison with commercially obtainable adhesive window fly traps, fly trap tests were carried out. For this purpose, four window areas in a private residence were respectively provided with a device according to the invention and a commercially available adhesive window fly trap over a total period of four weeks. To eliminate artefacts, these four traps were rotated on a weekly basis, i.e. respectively attached to a different window area. Used as devices according to the invention were specimens on which the support material consisted of colorless or yellow-colored plastic. They were attached vertically or substantially horizontally. For comparison, a transparent strip of glue from the Swedish company Silvandersson Miljö AB, Knäred, known in Germany by the trade name “Silva Fenserfliegenfalle” [Silva window fly trap], which is fastened directly to the window and attracts the insects, was used. In the case of this product, the adhesive area lies vertically while it is attached. The adhesive areas of all the traps used were virtually the same.

The catching results are reproduced in the following table:

| | Plastic | Plastic | Plastic | |
|---|---|---|---|---|
| | support | support | support | “Silva |
| | colorless, | colorless, | yellow, | Fenser- |
| | vertical | horizontal | vertical | fliegenfalle” |
| Week 1 | 26 | 30 | 7 | 26 |
| Week 2 | 10 | 57 | 6 | 39 |
| Week 3 | 8 | 3 | 4 | 7 |
| Week 4 | 15 | 29 | 8 | 26 |
| Total | 59 | 119 | 25 | 98 |

The “flies” caught within a week are indicated. These respectively include larger flying insects, which would be referred to by the average population (end-users) as house flies, but scientifically are not to be equated with Musca domestica. Smaller flying insects were not counted.

As shown, all the devices are capable of catching flying insects. On account of the horizontal attachment of the device, however, a much higher catching rate can be achieved than by a comparable, commercially obtainable product. The increase in the catching rate in comparison with the commercially obtainable product is about 20%. (If the catching result of the third week, attributable to cool weather and low occurrence of flying insects, is ignored, the increase is 27%.)

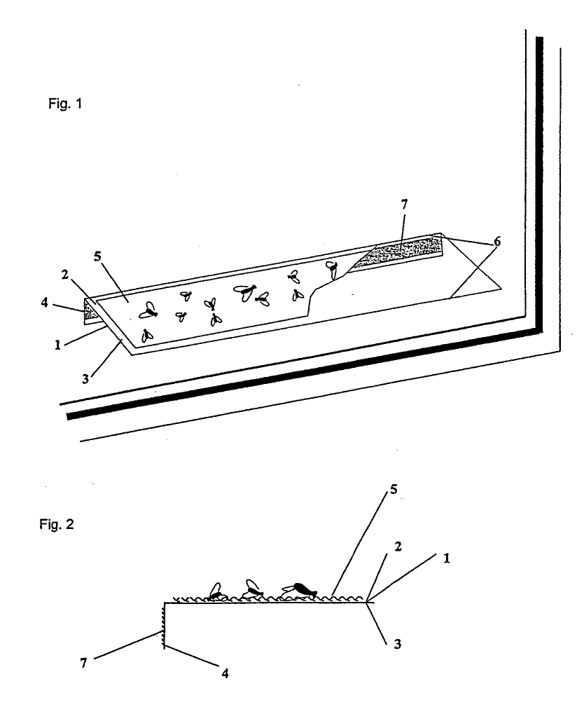

FIG. 1 shows a three-dimensional device for catching flying insects which is attached on the inside of a vertical window pane. The device itself has in this embodiment a rectangular form.

FIG. 2 shows a device for catching flying insects from the side, which is attached to a vertical wall.

In the figures, the reference numerals have the following meaning:

(1) planar support (trap body)

(2) first surface (upper side of the support), provided as insect catching area

(3) second surface (underside of the support), uncoated

(4) fastening device (material strip)

(5) layer containing substance which attracts insects and/or to which insects stick; the edge region facing the fastening device (4) being uncoated

(6) two parallel longitudinal sides, lying opposite each other, of the planar support

(7) strip of adhesive on averted side of the material strip

1. A device for catching flying insects, comprising a planar support (1) and a fastening device (4), the support (1) having a first surface (upper side) (2) and a second surface (lower side) (3), characterized in that at least one of the surfaces has a layer containing a substance (5) which attracts insects and/or to which insects stick.

2. The device as claimed in claim 1, characterized in that the planar support (1) consists of a material which is selected from the group comprising glass, board or plastic.

3. The device as claimed in claim 1 or 2, characterized in that the planar support (1) is substantially rigid and/or dimensionally stable.

4. The device as claimed in one or more of claims 1 to 3, characterized in that the plastic material forming the planar support (1) consists of a polymer based on polyester or polyester composite material.

5. The device as claimed in one or more of claims 1 to 4, characterized in that the planar support (1) is transparent and colored or colorless and, if appropriate, has a geometrical pattern.

6. The device as claimed in one or more of claims 1 to 5, characterized in that the planar support (1) is rectangular and has two parallel longitudinal sides (6), lying opposite each other.

7. The device as claimed in one or more of claims 1 to 6, characterized in that the fastening device (4) is a material strip which is attached to one of the longitudinal sides of the support (6), is arranged substantially perpendicularly to the surface of the support having the substance which attracts insects and/or to which insects stick and comprises a strip of adhesive (7) provided on the side of the material strip facing away from the planar support.

8. The device as claimed in one or more of claims 1 to 7, characterized in that the material strip (4) attached to the support (1) consists of the same material as the planar support (1).

9. The device as claimed in one or more of claims 1 to 8, characterized in that the material strip (4) attached to the planar support (1) can be produced by folding over a preferably uncoated edge region of the planar support (1), which runs on one of the longitudinal sides.

10. The device as claimed in one or more of claims 1 to 9, characterized in that the substance which attracts insects is a substance or combination of substances from the group comprising sexual pheromones, aggregation pheromones, feedants and pheromone attractants.

11. The device according to one of claims 1 to 10, characterized in that the substance which attracts insects is a substance or combination of substances from the group of adhesive substances which effectively prevents a flying insect sticking to it from flying away again.

12. A method of producing a device for catching flying insects which comprises a planar support (1) with an upper side (2), a lower side (3) and a fastening device (4), characterized by the steps of:
a) coating at least one surface of a planar material sheet with a composition containing a substance which attracts insects and/or to which insects stick, an edge region of this surface of the planar material sheet remaining uncoated,
b) covering the coated surface with a protective film which can be pulled off again,
c) introducing a delimiting line into the uncoated edge region of the planar material sheet, producing a material strip which is enabled to protrude permanently from the plane of the coated surface,
d) applying adhesive or a double-sided adhesive tape to one of the sides of the material strip,
e) covering the adhesive or the double-sided adhesive tape with a protective film which can be pulled off again.

13. The method as claimed in claim 12, characterized in that the introduction of the delimiting line is performed by folding over, notching or perforating.

14. The method as claimed in claim 12 or 13, characterized in that the adhesive or the double-sided adhesive tape is applied to the side of the material strip which respectively faces away from the plane of the coated surface.

15. The method as claimed in one or more of claims 12 to 14, characterized in that the introduction of a delimiting line is performed after at least one of steps a), b), e) or d).

16. The method as claimed in one or more of claims 12 to 15, characterized in that portions of the planar material sheet respectively provided with protective films which can be pulled off again, provided with a coated surface at least on one side and with a material strip provided with adhesive or a double-sided adhesive tape are cut up by cross-cutting or punching.
